(19) United States
(12) Patent Application Publication
(10) Pub. No.: US 2009/0074503 A1
(43) Pub. Date: Mar. 19, 2009

(54) Powder applicator apparatus and methods

(76) Inventor: Mary K. Conway, Long Beach, NY (US)

Correspondence Address: MCCARTER & ENGLISH, LLP, FOUR GATEWAY CENTER, 100 MULBERRY STREET, NEWARK, NJ, 07102, US

(21) Appl. No.: 11/901,064

(22) Filed: Sep. 13, 2007

(51) Int. Cl. B43K 5/00; B05C 21/00

(52) U.S. Cl. 401/202; 401/196; 401/205

(57) ABSTRACT

Apparatus and methods for application of body powder are disclosed. The apparatus and methods disclosed may have a body powder stored within a porous fabric material. As the fabric material is rubbed against the skin surface the powder is released onto the skin.

### FIELD OF THE INVENTION

The present invention relates generally to powder application, and more particularly to a device and method for applying powder to the body.

### BACKGROUND OF THE INVENTION

Body powders are applied to the skin's surface. The body powder may be used to dry the skin and/or interact with the skin cells. The body powder may act as an astringent, an antiperspirant, fungicide or other medicinal purpose. The body powder may also incorporate a fragrance to provide a perfume or cologne.

Typically, Body powder is applied by squeezing a bottle or shaking a bottle containing the powder upside down. The powder grains pass through a perforated top of the bottle directly onto the skin or are collected in the palm of the hand. The user then rubs the powder on the skin. Excess powder may be released into the air or fall to the ground. In addition, one may need to continuously apply powder.

Accordingly, a device, method, and system is needed to easily and efficiently apply body powder. In addition, the device, method and system may need to be easily storable and transportable. Further, the device, method, and system may need to dry and brush the skin of foreign particles while applying the body powder. Still further, the device, method and system may need to be cleanable and refillable.

### BRIEF DESCRIPTION OF THE DRAWINGS

The above and other objectives and advantages of the present invention will be apparent upon consideration of the following detailed description, taken in conjunction with the accompanying drawings, in which like reference numbers refer to like parts throughout, and in which:

FIG. 1A is a perspective view of the powder applicator 100 according to a first exemplary embodiment of the present invention.

FIG. 1B is a profile view of the powder passing through the powder applicator walls 104 according to an exemplary embodiment of the present invention.

FIG. 2 is a perspective view of the powder applicator 100 with container 200 according to a second exemplary embodiment of the present invention

FIG. 3 is a flow chart of the powder application according to a first exemplary method embodiment 300 of the present invention.

FIG. 4 is a flow chart of cleaning and refilling of powder applicator 100 according to a second exemplary method embodiment 400 of the present invention.

### DETAILED DESCRIPTION OF THE INVENTION

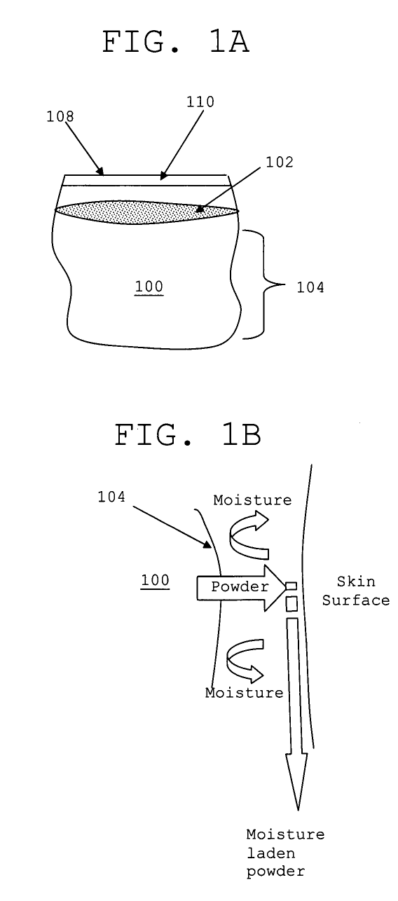

Referring to FIG. 1A, the powder applicator 100 is made of walls 104 that allows a body powder 102 stored in the powder applicator 100 to pass through to an outer surface of the powder applicator 100. The body powder 102 may be a variety of powders applied to the skin, for example but not limited to, talcum powder, cornstarch, fragrance powders, medicated powders, a combination of the forgoing powders, and/or any other suitable powder(s). The user rubs the outer surface of the walls 104 of the powder applicator 100 against the skin. The outer surface may brush the skin of foreign particles, for example but not limited to, sand, dirt, and dead skin. The walls 104 also allow body powder 102 to pass through and be applied to the skin. The powder applicator 100 may be used, for example, at the beach to remove sand from the skin.

According to the first exemplary embodiment, the powder applicator 102 may be made of a cotton fabric stitched together in a pocket shape. An aperture 108 may be provided for the powder applicator 100 to allow empting and/or refilling of the powder applicator 100. The aperture 108 may include a hook and loop fasteners seam 110 to allow the aperture 108 to remain closed during use but allow for quick access for refilling the powder applicator 100. The powder applicator 100 may use other suitable fasteners to provide closing of the aperture 108, for example but not limited to, snaps, zippers, drawstrings, or press and lock fasteners. The powder applicator 100 may also be designed without an aperture 108 to provide a limited use applicator. According to this embodiment, the powder applicator 100 would be filled during manufacturing and disposed by the user once the powder applicator 100 is emptied.

Referring to FIG. 1B, the powder applicator 100 is made of fabric walls 104 that allows a body powder 102 stored in the powder applicator 100 to pass through to an outer surface of the powder applicator 100. The fabric may be selected based on the desired amount of body powder 102 released and the grain size of the body powder 102. For example, increasing the porosity of the fabric will increase the amount of body powder 102 released. The fabric may be of a variety of materials, for example, the fabric may be a 100 percent blend of cotton fiber. The fabric material may be made of a material the wicks water from the skin. In another embodiment the fabric may be of a synthetic fiber, for example, spandex or elastane. The fabric material may be made of a material that does not readily absorb water and provides a relative dry surface. In another embodiment, the fabric may be a material that has unidirectional characteristics that allow the powder and moisture to pass to the outside of the powder applicator 100 but prevents moisture from flowing in the opposite direction into the powder applicator 100. One skilled the art will appreciate that other suitable material with similar properties as fabric walls 104 may be used in embodiments of the present invention. The powder applicator 100 may also be made with a combination of fabric and rigid portion and is not limited to a pocket shape. For example, a rigid handle or container may be incorporated into the design. In another example, the powder applicator 100 may have the shape of a seahorse, starfish, surfboard, life vest or other aesthetic shape.

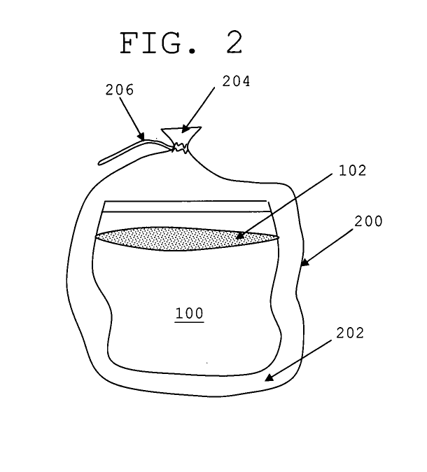

Referring to FIG. 2, the powder applicator 100 may include a container 200. The container 200 may be used to provide for storage and transportability of the powder applicator 100 when not in use. The container 200 may be made of a material that prevents the passage of body powder 102. A container aperture 204 may be provided for placing the powder applicator 102 within the container 200. The container aperture 204 may include a drawstring fasteners seam 206 to allow the container aperture 204 to remain closed during storage and/or transporting. The container 204 may use other fasteners to provide closing of the container aperture 204, for example but not limited to snaps, hook and loop, zipper, press and lock fasteners, or any other suitable fastener(s). Excess powder 202 remains inside the container 200 and may be disposed of or inserted back into the powder applicator 100. The container 200 may be made of a fabric that prevents the passage of powder or a rigid or semi rigid material, for example, plastic or leather. The container 200 may be made of a combination of fabric with a plastic lining.

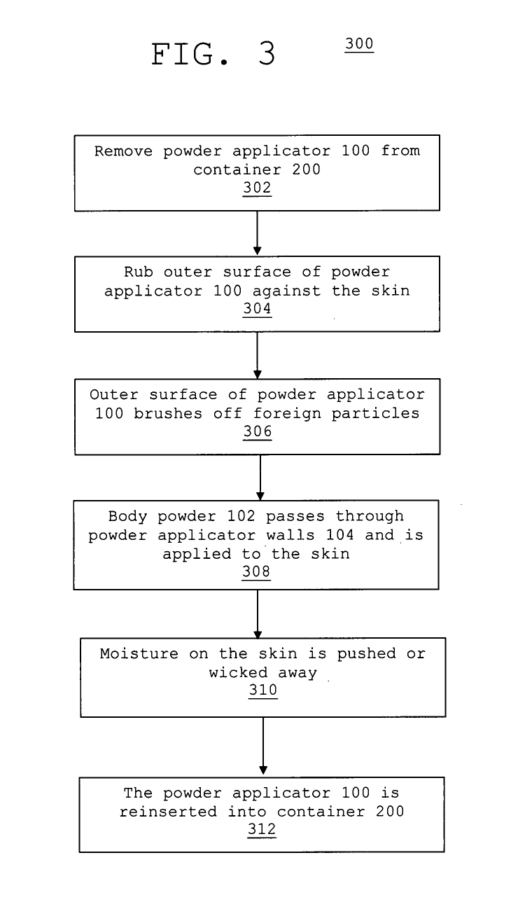

FIG. 3 is a flow chart of the powder application according to a first exemplary method embodiment 300 of the present invention. The user removes powder applicator 100 from container 200 (block 302). The user rubs the outer surface of powder applicator 100 against the skin (block 304). The outer surface of powder applicator 100 brushes off foreign particles, for example sand (block 306). Body powder 102 passes through powder applicator's walls 104 and is applied to the skin (block 308). The amount of powder dispensed may be dependent on fabric and powder characteristics. Moisture on the skin is pushed or wicked away (block 310). Moisture on the skin may be accomplished by some of the body powder 102 absorbing moisture and falling off the skin from repeated brushes. The powder applicator 100 is reinserted into container 200 for later use and/or transport (block 312).

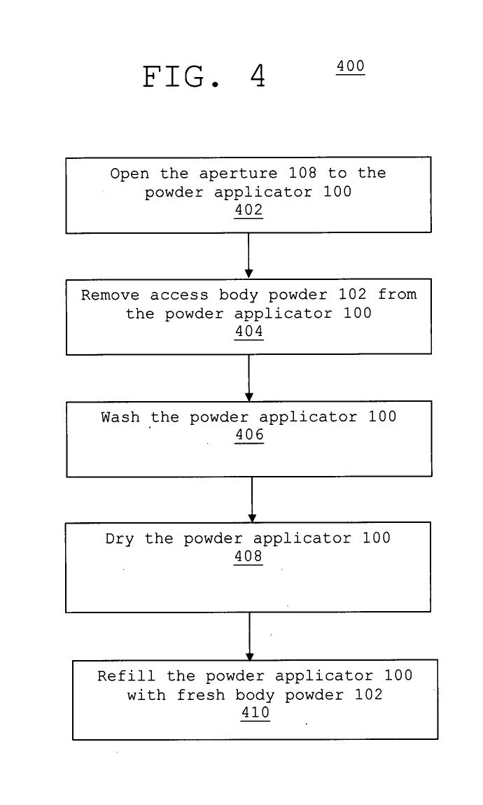

FIG. 4 is a flow chart of cleaning and refilling of the powder applicator according to a second exemplary method embodiment of the present invention. The aperture 108 to the powder applicator 100 is opened (block 402). Excess body powder 102 from the powder applicator 100 is removed through the aperture 108 (block 404). The powder applicator 100 is washed (block 406). This action may include, for example, washing the powder applicator 100 in a washing machine, sink, for by shaking or dry cleaning. The powder applicator 100 is allowed to dry (block 408). The powder applicator 100 is refilled with fresh body powder 102 (block 410). The powder applicator 100 is now recharged and ready for future use.

It will be understood that the foregoing is only illustrative of the principles of the invention and that various modifications can be made by those skilled in the art without departing from the scope and spirit of the invention. Accordingly, such embodiments will be recognized as within the scope of the present invention. Various aspects disclosed in the exemplary embodiments may be incorporated with aspects disclosed in other exemplary embodiments without departing from the scope of the invention. Persons skilled in the art will also appreciate that the present invention can be practiced by other than the described embodiments, which are presented for purposes of illustration rather than of limitation and that the present invention is limited only by the claims that follow.

What is claimed is:

1. An apparatus for removing sand from a skin surface comprising:
a powder applicator, wherein the applicator container is constructed of porous material in order to release powder at a substantially determined rate.

2. The apparatus of claim 1, wherein the porous material is a moisture absorbing material.

3. The apparatus of claim 2, wherein the porous moisture absorbing material is cotton.

4. The apparatus of claim 3, wherein the powder applicator is sealed by one of a drawstring, Velcro, one or more hooks, and one or more snaps.

5. The apparatus of claim 4, wherein the powder applicator is stored in a non-porous container.

6. The apparatus of claim 5, wherein the non-porous container is sealed by one of a drawstring, Velcro, one or more hooks, and one or more snaps.

7. The apparatus of claim 6, wherein the non-porous container is moisture resistant container.

8. A method of removing sand from a skin surface comprising the action of:
removing a powder applicator from a container;
rubbing an outer surface of the powder applicator against the skin;
brushing sand from the skin;
passing body powder through powder applicator walls onto skin; and
removing moisture on skin.

9. The method of claim 8, further comprising the action of:
reinserting the powder applicator into a powder container.

10. A method of removing sand from a skin surface comprising the action of:
removing a powder applicator from a container;
filling a powder application with powder;
touching an outer surface of the powder applicator against skin;
brushing sand from the skin;
passing a controlled amount of body powder through powder applicator walls onto skin;
removing moisture on skin; and
reinserting the powder applicator into a moisture resistant powder container.
